(19) United States
(12) Patent Application Publication
(10) Pub. No.: US 2002/0075186 A1
(43) Pub. Date: Jun. 20, 2002

(54) Chip antenna and method of manufacturing the same

(76) Inventors: Hiroki Hamada, Tokyo (JP); Yoshikazu Kamei, Tokyo (JP); Masayuki Ishiwa, Tokyo (JP)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 10/022,006

(22) Filed: Dec. 14, 2001

(30) Foreign Application Priority Data
Dec. 20, 2000 (JP) 2000-387151
Dec. 20, 2000 (JP) 2000-387150
Mar. 26, 2001 (JP) 2001-87141

(51) Int. Cl. H01Q 1/38; H01Q 1/24

(52) U.S. Cl. 343/700 MS; 343/702

(57) ABSTRACT

A chip antenna comprises an antenna element, and a dielectric chip having the antenna element buried therein or stacked on a surface thereof. Particularly, the dielectric chip has a space area, for example, a flute for forming an air layer on an underside (in a surface not in contact with the antenna element). By varying the size of the flute, the antenna characteristic is tuned while consistently maintaining the outer dimensions of the chip antenna and a mounting height for the antenna element.

### BACKGROUND OF THE INVENTION

1. Field of the Invention

The present invention relates to a chip antenna which is so structured as to have an antenna element buried in a dielectric chip, or an antenna element stacked on the surface of a dielectric chip, and a method of manufacturing the chip antenna.

2. Description of the Prior Art

As small-size antennas for use in mobile telephones, portable computers, wireless LAN (local area network) equipment and the like, attention is paid to a chip antenna which is comprised of an antenna element buried in a dielectric chip.

The characteristic of a chip antenna varies due to the influence exerted by a printed circuit board on which the chip antenna is mounted, and the like. For this reason, even for use in the same frequency band, a large number of types of chip antennas must be prepared in accordance with particular situations in which chip antennas are mounted on the printed circuit boards. In the past, therefore, a plurality of types of chip antennas having different characteristics have been prepared by changing the pattern shape and dielectric material of the antenna element. However, the preparation of such chip antennas inevitably requires tremendous time and labor.

### SUMMARY OF THE INVENTION

It is an object of the present invention to readily provide chip antennas having a variety of characteristics.

A chip antenna according to the present invention is so structured as to include an antenna element, and a dielectric chip having the antenna element buried therein or stacked on a surface thereof, particularly characterized in that the dielectric chip is formed with a space area for forming an air layer or a space area, for example, a flute, filled with another dielectric material different in dielectric constant from the dielectric chip.

Also, a method of manufacturing a chip antenna according to the present invention first fits a nest of a predetermined shape at a site for forming the space area in a mold for injection molding of the dielectric chip. Characteristically, after setting an antenna element in the mold, a dielectric material is injected into the mold to form the dielectric chip which has the space area for forming an air layer. Also, characteristically, the nest fitted in the mold is replaced to manufacture a plurality of types of chip antennas.

### BRIEF DESCRIPTION OF THE DRAWINGS

FIG. 1 is a perspective view illustrating the schematic structure of a chip antenna according to a first embodiment of the present invention;

FIG. 2 is a diagram schematically illustrating the cross-sectional structure of the chip antenna illustrated in FIG. 1;

FIG. 3 is a diagram illustrating an exemplary method of manufacturing the chip antenna illustrated in FIG. 1;

FIG. 4 is a perspective view illustrating the schematic structure of a chip antenna according to a second embodiment of the present invention;

FIG. 5 is a perspective view illustrating the schematic structure of a chip antenna according to a third embodiment of the present invention;

FIG. 6 is a perspective view illustrating the schematic structure of a chip antenna according to a fourth embodiment of the present invention;

FIGS. 7A, 7B, 7C and 7D are diagrams illustrating the schematic structure of a chip antenna according to a fifth embodiment of the present invention, where FIG. 7A is a plan view, FIG. 7B is a cross-sectional view taken along the line A-A in FIG. 7A, FIG. 7C is a left side view, and FIG. 7D is a right side view.

FIGS. 8A and 8B are diagrams illustrating the schematic structure of a chip antenna according to a sixth embodiment of the present invention, where FIG. 8A is a front view, and FIG. 8B is a cross-sectional view taken along the line B-B in FIG. 8A;

FIGS. 9A and 9B are diagrams illustrating the schematic structure of a chip antenna according to a seventh embodiment of the present invention, where FIG. 9A is a front view, and FIG. 9B is a cross-sectional view taken along the line C-C in FIG. 9A;

FIGS. 10A and 10B are diagrams illustrating the schematic structure of a chip antenna according to an eighth embodiment of the present invention, where FIG. 10A is a front view, and FIG. 10B is a cross-sectional view taken along the line D-D in FIG. 10A;

FIG. 11 is a perspective view illustrating the schematic structure of a chip antenna which comprises an adjustable element;

FIG. 12 is a plan view illustrating the schematic structure of the chip antenna illustrated in FIG. 11;

FIG. 13 is a diagram for explaining the principles of tuning the antenna characteristic of the chip antenna illustrated in FIG. 11, and a method of tuning the characteristic;

FIG. 14 is a frequency characteristic graph showing results of experiments which demonstrate changes in the antenna characteristic by bending the adjustable element;

FIG. 15 is a diagram illustrating the schematic structure of an antenna chip used in the experiments shown in FIG. 14;

FIGS. 16A, 16B and 16C are diagrams showing how the experiments shown in FIG. 14 were made, respectively;

FIG. 17 is a perspective view illustrating the schematic structure of another chip antenna which comprises an adjustable element;

FIG. 18 is a perspective view illustrating the schematic structure of a chip antenna according to a ninth embodiment of the present invention; and

FIG. 19 is a perspective view illustrating the schematic structure of a chip antenna according to a tenth embodiment of the present invention.

### DETAILED DESCRIPTION OF THE INVENTION

[First Embodiment]

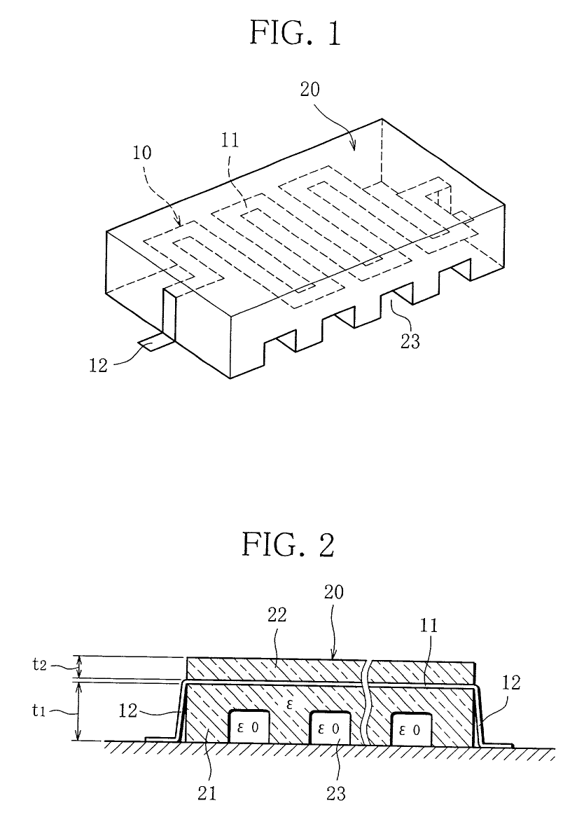

FIG. 1 is a perspective view illustrating the schematic structure of a chip antenna according to a first embodiment. The illustrated chip antenna comprises an antenna element 11 formed in an antenna conductor 10, for example, in a meander pattern, embedded in a dielectric chip 20 substantially in a rectangular solid, and a terminal element 12 continuous to the antenna element 11 which is led out of one end of the dielectric chip 20.

The antenna conductor 10 having a pattern shape which comprises the antenna element 11 and the terminal element 12 continuous to one end of the antenna element 11 is formed by patterning, for example, a conductive plate made of copper alloy by punching, etching or the like. Specifically, the meander antenna element 1 is fabricated by patterning a conductive plate 0.12 mm thick, for example, to form a conductive pattern having a conductive width of 0.2 mm, a meander width of 3.2 mm and a meander pitch of 0.6 mm over five turns. The chip antenna substantially in the shape of rectangular solid, formed by embedding the antenna element 11 in the dielectric chip 20 is realized generally in a size of 4 mm wide, 8 mm long and 2.8 mm thick.

The dielectric chip 20, as schematically illustrated in FIG. 2 which shows a cross-sectional structure thereof, comprises a dielectric layer 21 provided below the antenna element 11, and a second dielectric layer 22 provided over the first dielectric layer 21 for covering the antenna element 11. The first dielectric layer 21 basically serves to position the antenna element 11 at a predetermined mounting height with respect to a printed wiring board on which the chip antenna is mounted. In particular, the dielectric chip 20 has a structure formed with flutes 23 on the underside of the first dielectric layer 21 (the surface not in contact with the antenna element 11) as a space area for forming an air layer. The flutes 23 result in the realization of a chip antenna that has a varying average thickness of the first dielectric layer 21 and hence a varying effective dielectric constant of the dielectric chip 20.

Particularly, in this embodiment, the first dielectric layer 21 is defined to have a rather large thickness t1 of 2.18 mm such that the antenna element 11 is mounted at a sufficiently high mounting height position while generally maintaining a consistent figure of the chip antenna. On the other hand, the second dielectric layer 22 simply serves to prevent the antenna element 11 from separating, so that its thickness t2 is set relatively small, i.e., 0.5 mm. Then, the overall thickness (height) of the dielectric chip 20 including the thickness of the antenna element 11 is set to be the aforementioned 2.8 mm.

The depth of the flutes 23 is set, for example, at 1.8 mm at maximum. This maximum depth is a condition for stably supporting the antenna element 11 in such a manner that at least 0.5 mm of thickness remains in the dielectric layer 21 even at sites which are thinned for the formation of the flutes 23. The size (shape) of the flutes 23 is determined by specifications (antenna characteristic) required for a particular chip antenna, described later.

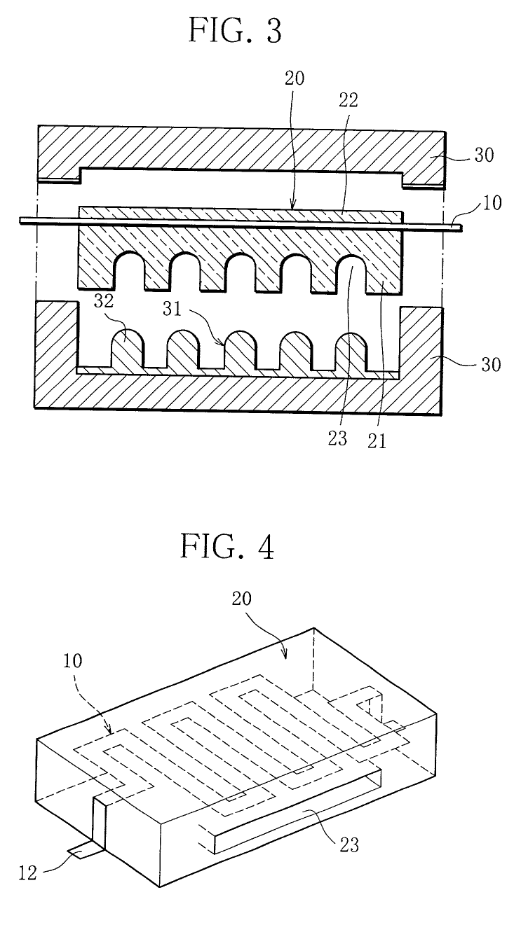

The chip antenna of the foregoing structure is basically manufactured, for example, using an injection mold 30 for insert mold, consisting of an upper die and under die, as illustrated in FIG. 3. Particularly, the chip antenna according to the first embodiment is manufactured using a nest 31 in a predetermined shape which is fitted in a die portion (under die) of the injection mold 30 for defining the shape of the lower surface of the antenna chip. The nest 31, which has protruding portions 32 corresponding to the flutes 23 formed on the underside of the dielectric chip 20, are previously fitted in the injection mold 30 to function as a portion of the mold 30.

The dielectric chip 20 of the chip antenna is manufactured by an insert mold method which involves setting the aforementioned antenna conductor 10 in the injection mold 30 having the nest 31 previously fitted therein, and then injecting a predetermined dielectric material into the injection mold 30. In this event, the resulting dielectric chip 20 is formed with the flutes (space) 23 on the underside by the protrusions 32 formed on the nest 31.

According to the chip antenna of the foregoing structure, the dielectric chip 20 itself, which has the antenna conductor 10 insert molded therein as illustrated in FIG. 2, precisely defines the height at which the antenna element 11 is mounted with respect to a grounding conductor on a printed wiring board, on which the chip antenna is mounted, by the dielectric layer 21 which is positioned below the antenna element 11. Also, the flutes 23 formed on the underside of the dielectric chip 20, i.e., in the lower surface of the dielectric layer 21 form an air layer between the grounding conductor on the printed wiring board and the antenna element 11.

As a result, when the size of the flutes 23, and hence the size of the air layer formed by the flutes 23 is changed in accordance with particular antenna specifications, the dielectric constant ε can be adjusted for the overall dielectric chip 20. Then, the characteristic of the chip antenna can be tuned by adjusting the dielectric constant. In other words, it is possible to readily implement chip antennas having a variety of specifications (antenna characteristic). This advantage is conspicuously desired for a type of antenna which is difficult in changing the shape of the antenna element 11 and accordingly difficult in tuning the characteristic, i.e., a type of chip antenna which has an antenna conductor 10 manufactured by press molding a metal plate.

Also, since the antenna according to the first embodiment has the thick first dielectric layer 21, the antenna conductor 10 can be set at a sufficiently high position, thereby extending the band. Further, since a wide adjusting range can be ensured for the depth of the flutes 23, the resonance frequency and frequency band can be tuned over a wide range. Since the antenna element 1 is covered with the second dielectric layer 22, the antenna element 11 is resistant to separation, thereby making it possible to implement a secure chip antenna which is stable in structure. Stated in another way, the chip antenna is free from such a problem as the antenna element prone to separation, as is the case with an antenna which has an antenna element placed on the top surface of a dielectric chip made of ceramic.

It is therefore possible to readily manufacture chip antennas which are adapted to a variety of specifications by previously providing a plurality of kinds of nests 31, for example, having protruding portions 32 in different sizes in accordance with antenna specifications, and selectively using these nests 31. In other words, chip antennas corresponding to a variety of antenna specifications can be readily manufactured only by selectively using a plurality of kinds of nests 31 without changing the body portion of the injection mold 30. Particularly, the resonance frequency and frequency band can be tuned for the antenna conductor 10 by changing the size of the flutes 23 while the antenna conductor 10 is set at a sufficiently high mounting position, thus providing significant practical advantages.

Also, when the second dielectric layer 22 above the antenna conductor 10 is reduced in thickness, and the underlying first dielectric layer 21 is increased in thickness, as described above, a dielectric material (resin), injected into the injection mold 30, generally tends to unevenly spread over the mold 30. In contrast, in the chip antenna according to the present invention, a narrow space region is partially defined by the protruding portion 32 of the nest 31 in order to form the flutes 23 in the first dielectric layer 21 on the underside of the antenna conductor 10, so that a dielectric material (resin) injected into the injection mold 30 spreads above and below the antenna conductor 10 in a well balanced manner. This results in additional advantages such as the ability to effectively carry out the injection molding of the dielectric chip 20.

It should be understood that the shape, size (area and depth) and number of the flutes 23 may be determined in accordance with particular antenna specifications.

[Second Embodiment]

In an alternative, the space area for forming an air layer may be a hole 24 opening along the antenna conductor 10 parallelly in the horizontal direction, as illustrated in FIG. 4. However, for forming such a hole 24, the injection mold 30 inevitably becomes more complicated because it must be structured such that the dielectric chip 20 can be removed from the mold 30. Therefore, the provision of the flutes 23 is preferred in practice.

[Third Embodiment]

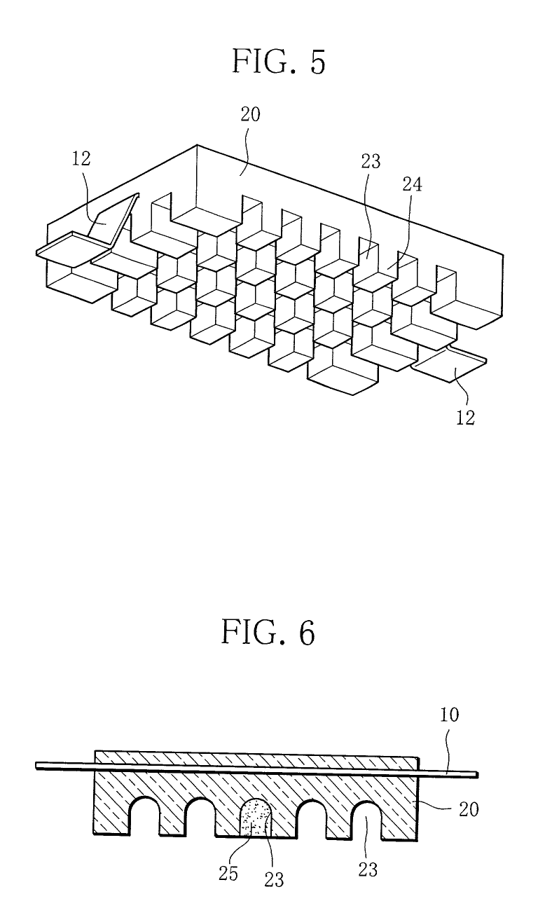

It is also possible to form a plurality of flutes 23 in the lower surface of the dielectric chip 20 extending vertically and horizontally in a matrix form, as illustrated in FIG. 5, to form a plurality of legs 25 on the lower surface of the dielectric chip 20. In this structure, since the legs 25 may be selectively removed to expand the space area on the underside of the dielectric chip 20, the antenna characteristic can be tuned after the chip antenna has been manufactured. Alternatively, a manufactured chip antenna may be slitted in the lower surface of the dielectric chip 20 as required with a cutter, a drill or the like to form a flute 23, thereby tuning the antenna characteristic.

[Fourth Embodiment]

Further, as illustrated in FIG. 6, another dielectric material 26 may be embedded in some (for example, one) of a plurality of flutes formed in the dielectric chip 20 to adjust the dielectric constant of the overall dielectric chip 20, thereby tuning the antenna characteristic. In this event, the dielectric material 26 may be made of the same material as the dielectric chip 20, or may be made of a different kind of dielectric material, as a matter of course. Further alternatively, the antenna characteristic may be tuned by employing a different kind of the dielectric material 26.

[Fifth Embodiment]

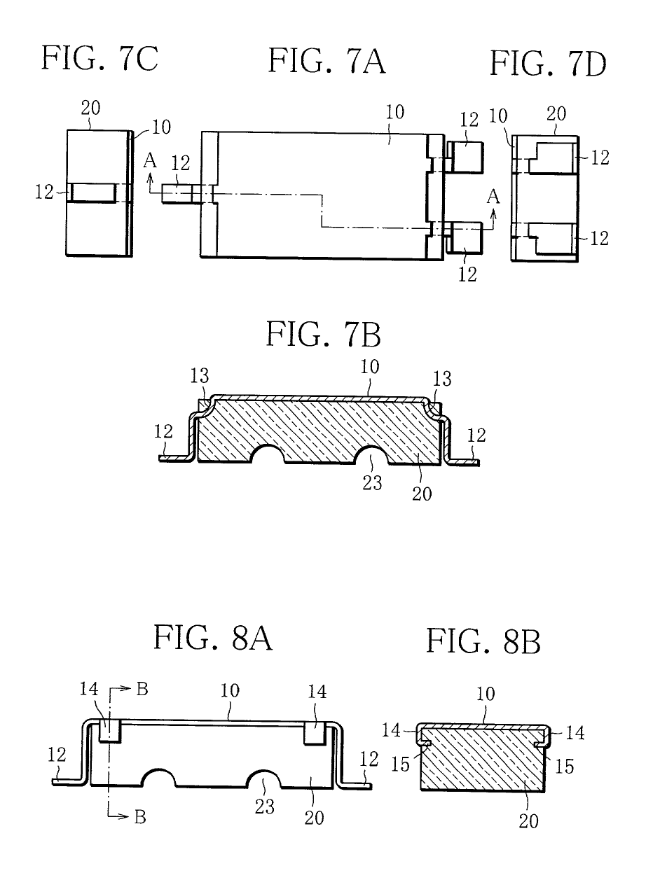

While the respective embodiments described above have shown the chip antenna which has the antenna element 11 embedded in the dielectric chip 20, the present invention may be applied as well to a chip antenna which has an antenna element 11 on the top surface of a dielectric chip 20. FIG. 7 illustrates an example of such a chip antenna, where FIG. 7A is a plan view; FIG. 7B is a cross-sectional view taken along the line A-A; FIG. 7C is a left side view; and FIG. 7D is a right side view.

The illustrated chip antenna is comprised of a dielectric chip 20, and an antenna conductor 10 (a patch antenna) adhered on the top surface of the dielectric chip 20 having an antenna element 11 made of a flat metal plate or the like. Below the dielectric chip 20, two flutes 23 each having a semi-circular cross-section are provided in parallel to form the aforementioned space area. Particularly, in this embodiment, each of bases of the terminal elements 12 connected to the ends of the antenna conductor 10 is curved downward in the form of quarter circle. The antenna conductor 10 is fixed on the top surface of the dielectric chip 20 by embedding the bases 13 in edge portions of the dielectric chip 20. This results in the structure in which the bases 13 of the terminal elements 12 and further the antenna conductor 10 are resistant to the separation from the surface of the dielectric chip 20.

Since such a structure permits the antenna conductor 10 to be carried on the top surface of the dielectric chip 20, the height of the antenna conductor 10 with respect to the grounding conductor of the circuit board on which the chip antenna is mounted can be set higher than the chip antenna embedded in the dielectric chip 20, as described above. It is therefore possible to readily implement a chip antenna which has a wide band. In addition, the flutes 23 formed in the lower surface of the dielectric chip 20 can facilitate the tuning of the antenna characteristic.

[Sixth Embodiment]

A chip antenna having a structure illustrated in FIG. 8 comprises side protrusions 14 bent in an L-shape at four locations along side edges near terminal elements 12 of a flat antenna conductor 10. Further, distal ends 15 of the side protrusions 14 are bent inward and embedded in lateral portions of a dielectric chip 20 as illustrated in FIG. 8B which shows a cross-sectional structure taken along the line B-B, to fix the antenna conductor 10 on the top surface of the dielectric chip 20.

[Seventh Embodiment]

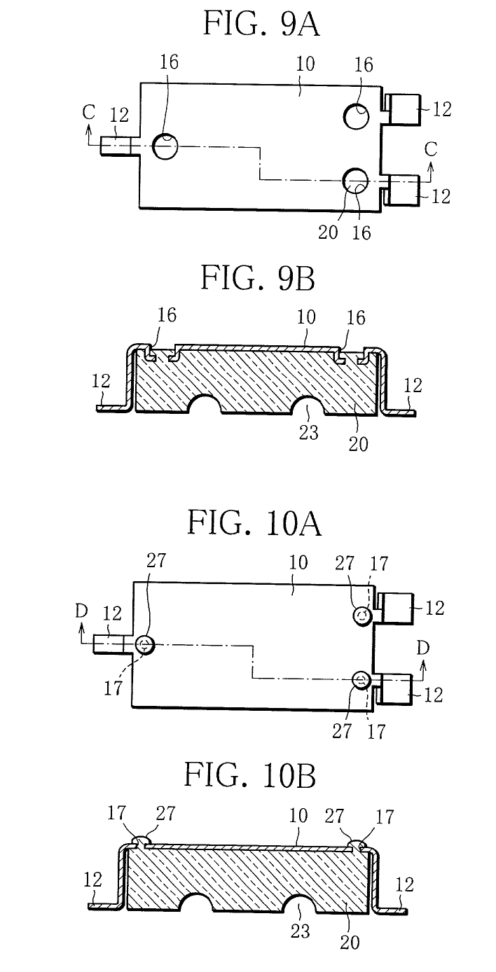

A chip antenna having the structure, as illustrated in FIG. 9A in plan view and in FIG. 9B in cross-sectional view taken along the line C-C, comprises a pit cavity 16 having a hole on the bottom surface, near a terminal element 12 in a flat antenna conductor 10. The pit cavity 16 is embedded in a dielectric chip 20. The pit cavity 16 may be formed by pressing a flat antenna conductor 10. As a dielectric resin is injected into a mold which has set therein the antenna conductor 10 having the pit cavity 16, the resin introduces into the pit cavity 16 through the hole, so that the pit cavity 16 is embedded by the resin as illustrated in FIG. 9B. As a result, the antenna conductor 10 is securely fixed on the top surface of the dielectric chip 20 with the resin which embeds the pit cavity 16.

[Eighth Embodiment]

Further alternatively, the chip antenna may have a structure as illustrated in FIGS. 10A, 10B in plan view and in cross-sectional view taken along the line D-D, respectively. The illustrated chip antenna comprises a flat antenna conductor 10 formed with a hole 17 extending therethrough near a terminal element 12 such that a portion of a dielectric chip 20 is bulged out through the hole 17 as illustrated in FIG. 10B, thereby securely fixing the antenna conductor 10 with the bulge 26 and the surface of the dielectric chip 20. For forming the bulge 26, a sink (not shown) may be formed for bulging out the resin at a site of a mold at which the hole 17 is positioned.

Likewise, in the chip antennas each having the antenna conductor 10 fixed on the top surface of the dielectric chip 20 in a variety of structures as described above, similar advantages can be provided as in the aforementioned embodiments by providing the flutes 23 in the lower surface of the dielectric chip 20 for forming a space area. Also, not limited to the flutes 23 having a semi-circular cross-section, the antenna characteristic can of course be tuned by varying the shape of the space area, as described above.

While the foregoing embodiments have illustrated the antenna conductor 10 formed with the meander antenna element 11 (first through fourth embodiments), and the antenna conductor 10 formed with the flat patch antenna (fifth through eighth embodiments), a micro-strip antenna or the like may be used instead. Further, instead of drawing out the terminal elements 12 from both longitudinal ends of the dielectric chip 20, the two terminal elements 12 may be drawn out in parallel from one end. In addition, the present invention can be applied as well to a chip antenna which is structured to draw out the terminal elements 12 from corners or the like of the dielectric chip 20.

Also, the dielectric chip 20, or the first and second dielectric layers 21, 22 may be comprised of a plurality of layers, respectively. Further, for the dielectric chip 20, resin materials may be used as appropriate, such as a resin/ceramics composite material which is a mixture of PPS (polyphenylene sulfide) and BaO—Nd₂O₃—TiO₂—Bi₂O₃ based ceramics powder, or a resin material such as LCP (liquid crystal polymer). The dielectric constant ε of such material may be, for example, in a range of approximately 3.1 to 20, though depending on particular antenna specifications.

As illustrated in the foregoing embodiments, the chip antenna according to the present invention has a space area in the dielectric chip, so that the antenna characteristic can be readily tuned by making use of the space area. Therefore, even for manufacturing small amounts of various chip antennas having different antenna characteristics, it is possible to readily realize chip antennas which satisfy various specifications only by varying the size of the space area or filling different dielectric materials in the space area, while consistently maintaining the outer dimensions of the chip antenna and the height of the antenna conductor.

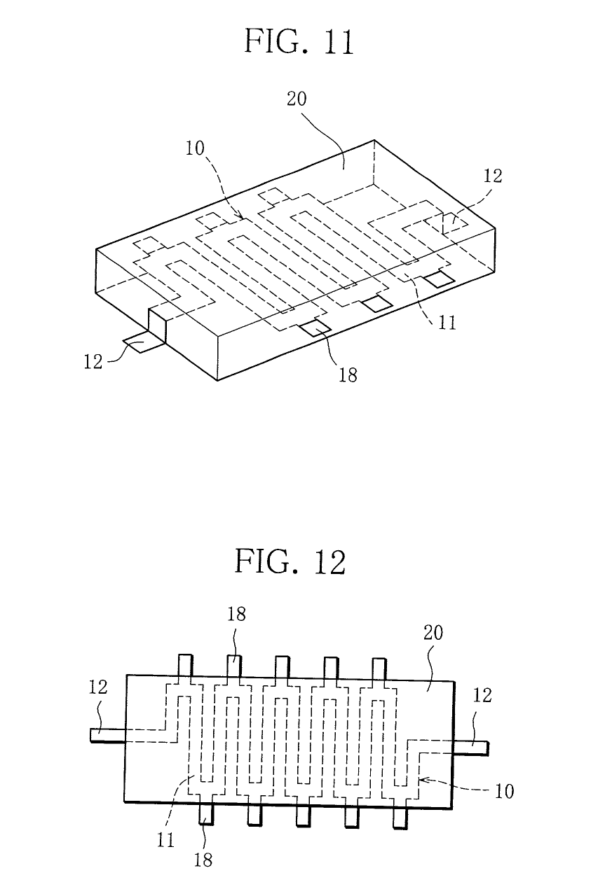

As can be seen, for example, in FIG. 11 which schematically illustrates the structure of a chip antenna, an adjustable element 18 may be formed continuous to the antenna element 11 embedded in the dielectric chip 20 such that the characteristic of the chip antenna can be tuned by leaving the adjustable element 18 projecting from one side of the dielectric chip 20.

Specifically, as illustrated in FIG. 12 which shows the structure in plan view, the adjustable elements 18 comprised of conductor pieces protrusively formed to the outside are provided along opposing sides of the antenna element 11, particularly at folded areas of the conductor. Then, the distal ends of the adjustable elements 18 are protruded out of the sides of the dielectric chip 20 by a predetermined length. Specifically, portions of the antenna element 11 in the antenna conductor 10 embedded in the dielectric chip 20 are provided as adjustable elements 18 continuous to the antenna element 11. The resulting chip antenna has the adjustable elements 18 protruding outward from the sides of the dielectric chip 20 and positioned in the external space.

According to the chip antenna having the foregoing structure, its antenna characteristic is principally defined by the antenna element 11 which constitutes a main portion thereof. However, since the foregoing chip antenna comprises the adjustable elements 18 continuous to the antenna element 11, the existence of the adjustable elements 18 is an essential factor for determining the antenna characteristic. The adjustable elements 18, however, relatively less affect the antenna characteristic since they, protruding from the dielectric chip 20, are positioned in the space area.

Specifically, the characteristic of the chip antenna having the foregoing structure is principally determined by the height, from the grounding conductor on a printed circuit board or the like, at which the antenna is mounted (the thickness of the dielectric chip 20 positioned below the antenna element 11), when the chip antenna is mounted on the printed circuit board, and the dielectric constant ε of the dielectric chip 20 intervening between the grounding conductor and the antenna element 11. In this event, though the adjustable elements 18 are positioned basically at the same height as the antenna element 11, they relatively less affect the antenna characteristic because only an air layer (having a dielectric constant ε_{O}) exists between the adjusting element 18 and the grounding plane.

However, the adjustable elements 18 can be readily cut since they protrude from the dielectric chip 20 and are positioned in the external space. A reduction in length of an adjustable element 18, by cutting it, results in a smaller capacitance formed between the adjustable element 18 and the grounding plane, and a shorter electric length of the antenna, thereby making it possible to increase the resonant frequency of the antenna element 11.

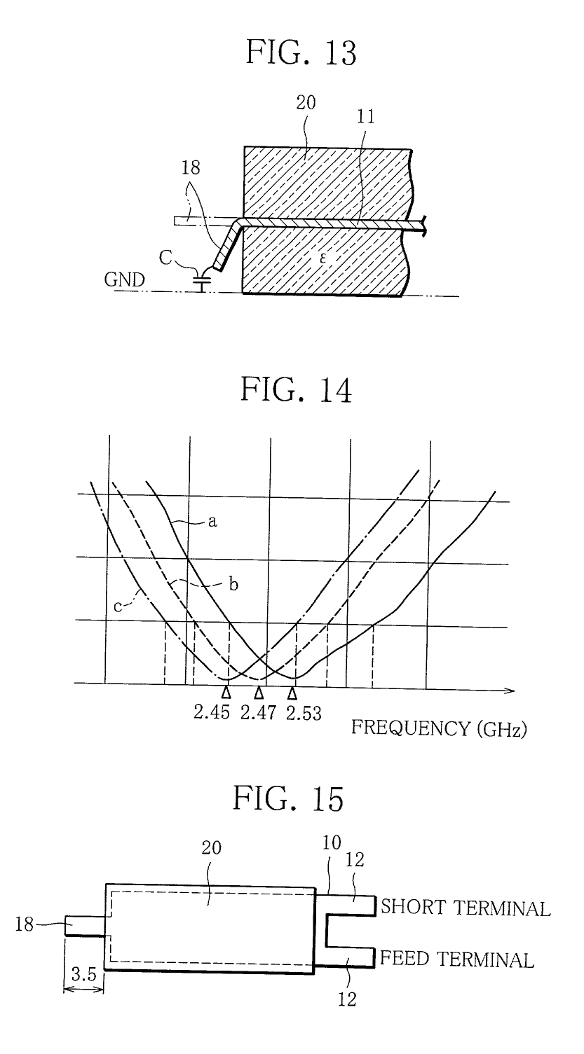

Also, as illustrated in FIG. 13, when an adjustable element 18 protruding outside the dielectric chip 20 is bent downward, the height of the adjustable element 18 changes with respect to the grounding conductor (GND). This results in a change in the capacitance C formed between the adjustable element 18 and the grounding conductor. Eventually, this capacitance C will largely affect the antenna characteristic.

For example, when an adjustable element 18 is bent downward to approach the grounding conductor, the adjustable element 18 more affects the antenna element 11, resulting in a reduction in the resonant frequency of the antenna element 11. Conversely, when an adjustable element 18 is bent upward further away from the grounding conductor, the adjustable element 18 slightly less affects the antenna element 11, resulting in a slight increase in the resonance frequency of the antenna element 11. In this manner, the resonance frequency and frequency band of the antenna element 11 change associated with a cut or bent adjusting element 18. It is therefore possible to tune the resonance frequency and frequency band of the antenna element 11 by cutting or bending the adjustable element(s) 18 protruding from the sides of the dielectric chip 20.

Specifically, FIG. 14 shows the characteristic of the chip antenna which changes when an adjustable element 18 is bent as described above. More specifically, FIG. 14 shows the result of an experiment which demonstrates exemplary changes in the resonance frequency and frequency band of the chip antenna. The experiment was made using an experimental chip antenna, the structure of which is illustrated in plan view of FIG. 15, by way of example. The illustrated antenna conductor 10 had at one end thereof a terminal element 12a short-circuited for termination and a feed terminal element 12b, and at the other end thereof an adjustable element 18. The antenna conductor 10 was insert molded by a dielectric chip 20 to complete the experimental chip antenna.

Basically, the experimental chip antenna was designed for 2.5 GHz. Then, the antenna conductor 10 was insert molded into the dielectric chip 20 having a thickness of 2.8 mm such that the resulting height reached 2.3 mm to fabricate the experimental chip antenna. The length of the adjustable element 18 was chosen to be 3.5 mm.

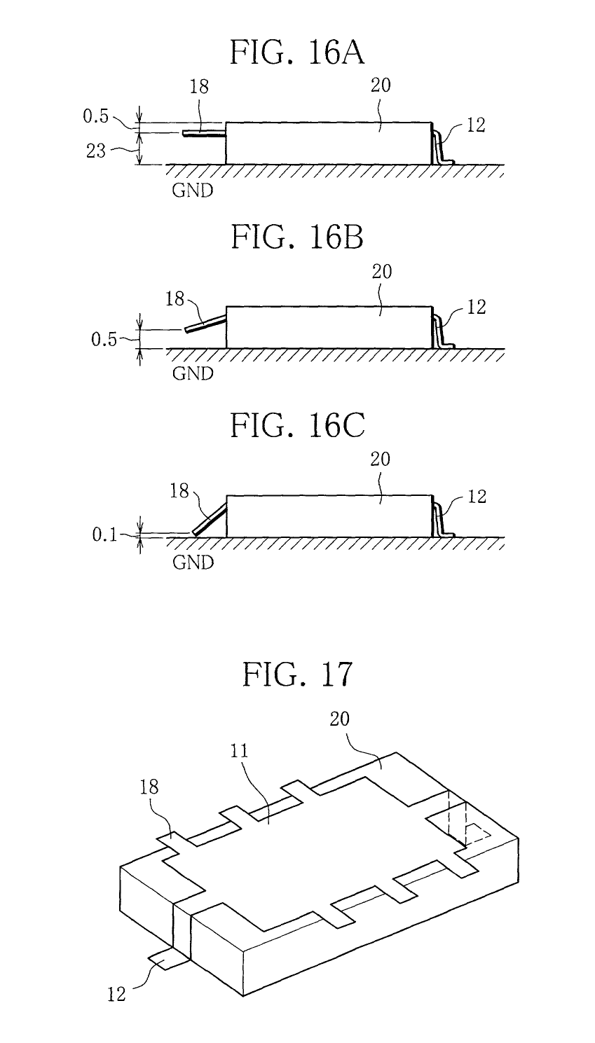

Then, the antenna frequency characteristic was examined when the adjustable element 18 of the experimental chip antenna was maintained in the horizontal state as illustrated in FIG. 16A; when the adjustable element 18 was bent such that its distal end was positioned at a height of 0.5 mm with respect to the grounding conductor as illustrated in FIG. 16B; and when the adjustable element 18 was bent such that its distal end was positioned at a height of 0.1 mm with respect to the grounding conductor as illustrated in FIG. 16C.

As a result, with the adjustable element 18 maintained in the horizontal direction (the state illustrated in FIG. 16A), the resulting antenna characteristic exhibited the resonance frequency at 2.53 GHz and the frequency band in a range of 2.45 to 2.63 GHz, as indicated by a characteristic curve a (solid line) in FIG. 14. On the other hand, when the adjustable element 18 was bent such that its distal end reached the height of 0.5 mm (the state illustrated in FIG. 16B), the resulting antenna characteristic changed, i.e., the resonance frequency was reduced to 2.49 GHz and the frequency band to 2.41 to 2.57 GHz, as indicated by a characteristic curve b (broken line). Further, when the adjustable element 18 was bent such that its distal end reached the height of 0.1 mm (the state illustrated in FIG. 16C), the resulting antenna characteristic changed, i.e., the resonance frequency was reduced to 2.45 GHz and the frequency band to 2.37 to 2.53 GHz, as indicated by a characteristic curve c (one-dot chain line).

As is apparent also from the foregoing result of experiment, the antenna characteristic, particularly, the resonance frequency can be readily changed by bending the adjustable element 18 protruding externally from the dielectric chip 20. In addition, as will be apparent, when the adjustable element 18 is cut away to change its length, the antenna characteristic (resonance frequency) can be increased as well. Thus, the antenna characteristic basically possessed by the chip antenna can be readily changed only by cutting or bending the adjustable element 18. It is therefore possible to readily and effectively adapt the characteristic of the chip antenna to a variety of antenna specifications.

In addition, even when the adjustable element 18 is cut or bent in the foregoing manner, the antenna element 11, the principal portion of the chip antenna, is embedded in the dielectric chip 20 and stably held by the dielectric chip 20, so that the cut or bent adjustable element 18 will never cause a change in the basic antenna characteristic itself determined mainly by the antenna element 11. Thus, the antenna characteristic can be readily and effectively change only in a range affected by the adjustable element 18.

For tuning the antenna characteristic of the chip antenna by cutting or bending the adjustable element 18 as described above, reference specifications, for example, may be defined for a variety of specifications to which the chip antenna should be adapted. Then, in accordance with required specifications, the adjustable element 18 of the chip antenna may be cut or bent in conformity to a predetermined procedure to implement a chip antenna which satisfies the required antenna specifications.

Specifically, the adjustable element 18 of the chip antenna provided as a standard item may be cut to leave a predetermined length or bent to a previously required angle by selectively using tools prepared for a variety of specifications to have the chip antenna satisfy the specifications.

Alternatively, after the chip antenna provided as a standard item is mounted on a printed circuit board or the like, the antenna chip may be tuned to satisfy the antenna characteristic by cutting or bending the adjustable element 18 while monitoring the antenna characteristic. In this event, once the adjustable element 18 is cut, it is difficult to restore the original shape. It is therefore desirable to roughly tune the antenna characteristic by cutting the adjustable element 18 before finely tuning the antenna characteristic by bending the adjustable element 18.

According to the foregoing method of tuning the characteristic of the chip antenna, the antenna characteristic can be readily set to a desired resonant frequency in a variable manner. As such, this eliminates the need for individually designing chip antennas in accordance with a variety of antenna specifications, thereby making it possible to largely reduce the development and manufacturing cost. Moreover, since the chip antenna provided as a standard item can be adapted to a variety of antenna specifications, this tuning method is suitable for flexible (small lot and multiproduct) production of chip antennas.

It should be noted that the foregoing tuning method can be applied as well to the chip antenna which has the antenna conductor 10 placed on the dielectric chip 20 as illustrated in FIG. 17. In this event, the antenna characteristic can also be varied as in the foregoing embodiment by cutting or bending adjustable elements protruding from opposing sides of the dielectric chip 20.

[Ninth Embodiment]

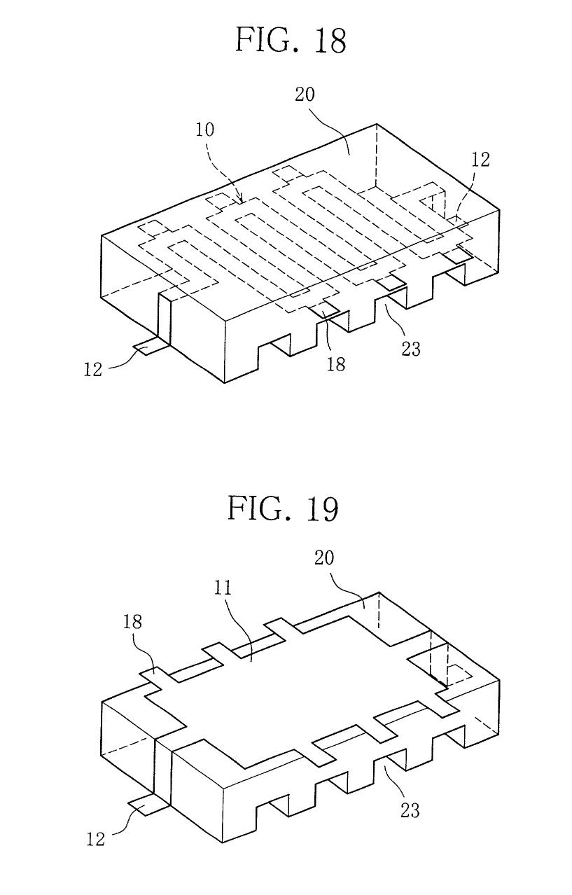

As illustrated in FIG. 18, with the provision of the aforementioned adjustable elements 18 in the chip antenna formed with the flutes 23 in the lower surface of the dielectric chip 20 (first dielectric layer 21) embedded with the antenna element 11, the antenna characteristic roughly tuned by the flute 23 can be finely tuned using the adjustable elements 18.

[Tenth Embodiment]

Further, as illustrated in FIG. 19, with the provision of the aforementioned adjustable element 18 in the chip antenna formed with the flutes 23 in the lower surface of the dielectric chip 20 provided with the antenna element 11 placed thereon, the antenna characteristic roughly tuned by the flutes 23 can be finely tuned using the adjustable elements 18.

Thus, the characteristic of the chip antenna can be widely tuned with the size (shape) of the flutes 23 which form a space area in the lower surface of the dielectric chip 20, and the adjustable elements 18 protruding from opposing sides of the dielectric chip 20. Moreover, chip antennas with a variety of characteristics can be implemented without changing the basic size of the chip antennas or the material of the dielectric chip 20.

In addition, a plurality of the adjustable elements 18 may be formed such that these adjustable elements 18 are selectively (partially) cut or bent, so that a wide characteristic tunable range can be set for the chip antenna. Then, it is possible to implement a chip antenna which can support a wide variety of antenna specifications by tuning the resonant frequency and frequency band which constitute the antenna characteristic.

[Inventions Recognizable from Foregoing Embodiments]

From the respective embodiments described above, the following inventions can be recognized.

(1) A chip antenna comprising an antenna element, and a dielectric chip having the antenna element buried therein or stacked on a surface thereof, wherein the dielectric chip includes a space area for forming an air layer or a space area filled with another dielectric material different in dielectric constant from the dielectric chip.

(2) A chip antenna comprising an antenna element, and a dielectric chip having the antenna element buried therein, wherein the dielectric chip includes a first dielectric layer for defining a mounting height for the antenna element, a second dielectric layer disposed above the first dielectric layer for covering the antenna element, and a space area formed in the first dielectric layer to form an air layer.

(3) A chip antenna comprising an antenna element, and a dielectric chip having the antenna element stacked on a surface thereof, wherein the dielectric chip has a thickness for defining a mounting height for the antenna element, and an air area for forming an air layer.

(4) In the chip antenna described in (1) to (3) described above, the space area comprises one or a plurality of flutes formed in a surface of the dielectric chip not in contact with the antenna element, wherein each of the flutes has a shape for changing an effective dielectric constant of the dielectric chip.

(5) A method of manufacturing a chip antenna having an antenna element buried in a dielectric chip or stacked on a surface of the dielectric chip, characterized by fitting a nest in a mold for injection molding of the dielectric chip for defining a space area for forming an air layer in the lower surface of the dielectric chip, setting an antenna element in the mold, and injecting a dielectric material into the mold to form the dielectric chip.

(6) In the method of manufacturing a chip antenna described in (5), characterized in that the mold comprises a pair of upper die and under die, wherein the nest for forming a space area is replaceably fitted in a cavity in the under die for forming the lower surface of the dielectric chip.

(7) In the method of manufacturing a chip antenna described in (6), characterized by preparing a plurality of kinds of the nests for selectively fitting in the mold, and replacing the nest fitted in the mold to manufacture a plurality of types of chip antennas.

(8) In the method of manufacturing a chip antenna described in (5), characterized in that the nest includes a protruding portion for forming one or a plurality of flutes on the lower surface of the dielectric chip.

(9) A chip antenna comprising an adjustable element disposed in a side portion of an antenna element, and protruding from one side of a dielectric chip.

The adjustable element is implemented as a conductor piece formed at a folded area of a meander antenna element, protruding to the outside. When folded areas exist at a plurality of locations of the antenna element, an adjustable element may be formed at each of the plurality of folded areas.

The antenna characteristic can be tuned by cutting or bending the adjustable element protruding from one side of the dielectric chip. While the antenna characteristic may be tuned before the chip antenna is mounted on a printed circuit board or the like, the tuning may be performed with the mounted chip antenna, for example, while measuring the antenna characteristic.

According to the chip antenna having the foregoing structure, the antenna characteristic can be readily tuned with the space area formed in the dielectric chip, and the adjustable element formed protrusively from one side of the dielectric chip. The chip antenna is therefore suitable for manufacturing a variety of chip antennas different in the antenna characteristic from one another on a flexible production basis. Specifically, chip antennas adapted to a variety of antenna specifications (for example, the resonant frequency and frequency band) can be readily implemented only by changing the size of the space area, filling a different dielectric material, or cutting or bending the adjustable element, while consistently maintaining the outer dimensions of the antenna chip and the height of the antenna conductor.

What is claimed is:

1. A chip antenna comprising an antenna element, and a dielectric chip having said antenna element buried therein or stacked on a surface thereof, wherein:
said dielectric chip includes a space area for forming an air layer or a space area filled with another dielectric material different in dielectric constant from said dielectric chip.

2. A chip antenna comprising an antenna element, and a dielectric chip having said antenna element buried therein, wherein:
said dielectric chip includes a first dielectric layer for defining a mounting height for said antenna element, a second dielectric layer disposed above said first dielectric layer for covering said antenna element, and a space area formed in said first dielectric layer to form an air layer.

3. A chip antenna comprising an antenna element, and a dielectric chip having said antenna element stacked on a surface thereof, wherein:
said dielectric chip has a thickness for defining a mounting height for said antenna element, and an air area for forming an air layer.

4. The chip antenna according to any of claims 1 to 3, wherein:
said space area comprises one or a plurality of flutes formed in a surface of said dielectric chip not in contact with said antenna element, said flutes each having a shape for changing an effective thickness of said dielectric chip.

5. A method of manufacturing a chip antenna having an antenna element buried in a dielectric chip or stacked on a surface of said dielectric chip, said method comprising the steps of:
fitting a nest in a mold for injection molding of said dielectric chip for defining a space area for forming an air layer in an lower surface of said dielectric chip;
setting an antenna element in said mold; and
injecting a dielectric material into said mold to form said dielectric chip.

6. The method of manufacturing a chip antenna according to claim 5, wherein:
said mold comprises a pair of upper die and under die, wherein said nest for forming a space area is replaceably fitted in a cavity in the under lie for forming the lower surface of said dielectric chip.

7. The method of manufacturing a chip antenna according to claim 5, further comprising the steps of:
preparing a plurality of kinds of said nests for selectively fitting in said mold; and
replacing said nest fitted in said mold to manufacture a plurality of types of chip antennas.

8. The method of manufacturing a chip antenna according to claim 5, wherein:
said nest includes a protruding portion for forming one or a plurality of flutes on the lower surface of said dielectric chip.
